(19) United States
(12) Patent Application Publication
(10) Pub. No.: US 2012/0309423 A1
(43) Pub. Date: Dec. 6, 2012

(54) APPARATUS AND METHOD FOR OBTAINING LOCATION INFORMATION OF AN ACCESSORY DEVICE IN A WIRELESS COMMUNICATION SYSTEM

(75) Inventor: Yong-Joon Jeon, Hwaseong-si (KR)

(73) Assignee: Samsung Electronics Co., Ltd., Gyeonggi-do (KR)

(21) Appl. No.: 13/483,684

(22) Filed: May 30, 2012

(30) Foreign Application Priority Data
May 30, 2011 (KR) 10-2011-0051344

(51) Int. Cl. H04W 4/02

(52) U.S. Cl. 455/456.2

(57) ABSTRACT

Obtaining location information of an accessory location device having no location estimation function, through a short-range communication function includes determining whether a message transmission period arrives, and when the message transmission period arrives, transmitting a message including at least one of an indicator indicating that location information transmission is requested to a first device, identification information of an accessory location device, and identification information of the first device.

### PRIORITY

The present application claims priority under 35 U.S.C. §119(a) to a Korean patent application, which was filed in the Korean Intellectual Property Office on May 30, 2011, and assigned Serial No. 10-2011-0051344, the entire disclosure of which is hereby incorporated by reference.

### BACKGROUND OF THE INVENTION

1. Field of the Invention

The present invention relates generally to a wireless communication system, and more particularly, the present invention relates to an apparatus and a method for obtaining location information of an accessory device having no location estimation function in the wireless communication system.

2. Description of the Related Art

Various devices including smart phones are capable of providing location-based services, through the device's location estimation function. Accordingly, a device for providing location-based services typically includes means such as a Global Positioning System (GPS) receiver, for estimating location.

For a service for informing the estimated location to another device, a device for estimating the location needs to include not only a means for estimating the location but also a communication means for transferring the location information, which would have a high manufacture cost and incur a considerable maintenance cost.

When the location estimation and provision functionalities are implemented in a portable terminal such as a smart phone or a cellular phone, the portable terminal, which originally has a communication function, can avoid the considerable burden in terms of the cost as discussed above. However, when the location estimation and provision functions are executed in a particular object, not in the portable terminal, the equipment of the location estimation means and the communication means is quite burdensome in terms of the cost.

Accordingly, there is a need for a solution that provides a service which estimates the location of a particular object and transfers the estimated location while reducing the cost.

### SUMMARY OF THE INVENTION

Accordingly, the present invention is designed to solve at least the above-described problems and/or disadvantages and to provide at least the advantages below.

Accordingly, one aspect of the present invention is to provide an apparatus and a method for estimating a location at a low cost and transferring the estimated location in a wireless communication system.

Another aspect of the present invention is to provide an apparatus and a method for obtaining and providing location information of a device without location estimation means in a wireless communication system.

Yet another aspect of the present invention is to provide an apparatus and a method for transferring location information via other devices in the same vicinity, in a wireless communication system.

According to one aspect of the present invention, a method for an apparatus having a short-range communication function includes determining whether a message transmission period arrives, and when the message transmission period arrives, transmitting a message including at least one of an indicator indicating that location information transmission is requested to a first device, identification information of an accessory location device, and identification information of the first device.

According to another aspect of the present invention, a method for an apparatus having a location estimation function includes receiving a message requesting to transmit location information from a first device through short-range communication, extracting identification information of a second device from the message, estimating a current location based on the first device, and transmitting the estimated location information to the second device.

According to yet another aspect of the present invention, an apparatus having a short-range communication function includes a controller for determining whether a message transmission period arrives, and when the message transmission period arrives, generating a message including at least one of an indicator indicating that location information transmission is requested to a first device, identification information of an accessory location device, and identification information of the first device, and a short-range communication module for transmitting the message.

According to still another aspect of the present invention, an apparatus having a location estimation function includes a short-range communication module for receiving a message requesting to transmit location information from a first device, a controller for extracting identification information of a second device from the message, a location estimation module for estimating a current location, and a network communication module for transmitting location information to the second device.

### BRIEF DESCRIPTION OF THE DRAWINGS

The above and other aspects, features and advantages of the present invention will be more apparent from the following description taken in conjunction with the accompanying drawings, in which:

FIG. 1 is a diagram illustrating a wireless communication system according to an embodiment of the present invention;

FIG. 2 is a flowchart illustrating operations of an accessory location device in the wireless communication system according to an embodiment of the present invention;

FIG. 3 is a flowchart illustrating operations of a location information provider in the wireless communication system according to an embodiment of the present invention;

FIG. 4 is a block diagram illustrating the components of the accessory location device of the wireless communication system according to an embodiment of the present invention; and

FIG. 5 is a block diagram of the location information provider in the wireless communication system according to an embodiment of the present invention.

Throughout the drawings, like reference numerals will refer to like parts, components and structures.

### DETAILED DESCRIPTION OF EMBODIMENTS OF THE INVENTION

Various embodiments of the present invention will be described in detail herein below with reference to the accompanying drawings. In the following description, well-known functions or constructions are not described in detail to avoid obscuring the description of the invention in unnecessary detail.

According to an aspect of the present invention, a technique for estimating a location at a low cost and providing the estimated location in a wireless communication system is provided.

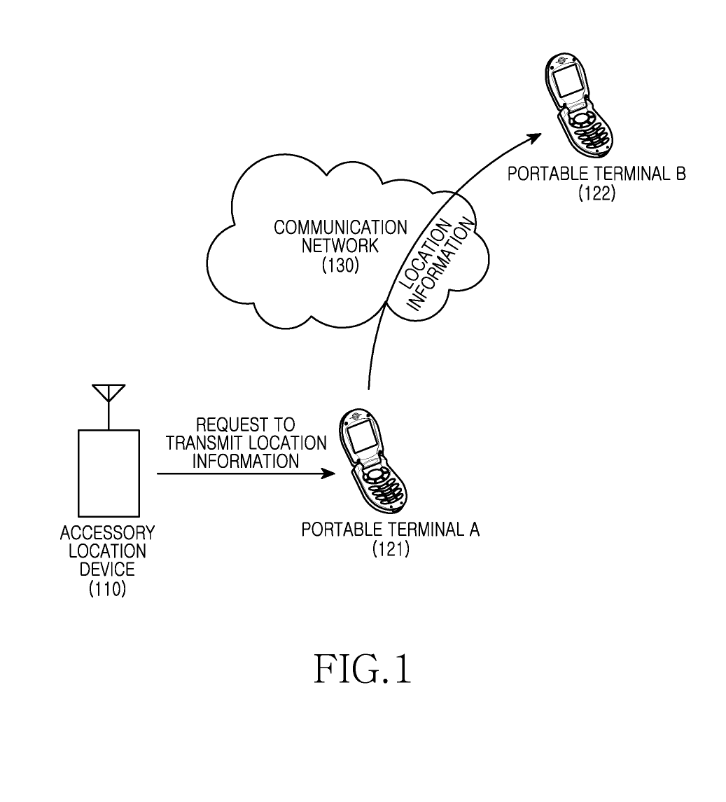

FIG. 1 is a diagram of a wireless communication system according to an embodiment of the present invention.

Referring to FIG. 1, the wireless communication system includes an accessory location device 110, a portable terminal A 121, a portable terminal B 122, and a communication network 130.

The accessory location device 110 is the target of location estimation, and the portable terminal B 122 estimates the location. The portable terminal A 121 and the portable terminal B 122 are clients of the wireless communication system, and the communication network 130 is a backbone network of the wireless communication system. The present invention provides a method for estimating a location of the accessory location device 110 and providing the location of the accessory location device 110 to the portable terminal B 122.

The accessory location device 110 includes a module for short-range communication, and sends a message including identification information of the portable terminal B 122 and identification information of the accessory location device 110 through the short-range communication module. For example, the short-range communication can include Radio Frequency IDentifier (RFID), Near Field Communication (NFC), Bluetooth®, and the like. When the short-range technology for adjusting a communication distance is applied, the service can be provided more easily and accurately.

The accessory location device 110 stores the identification information of the portable terminal B 122. For example, the identification information can be at least one of a phone number, an e-mail, an identifier allocated in the communication network 130, and an IDentifier (ID) of a particular community service. The identification information can be stored in various ways according to the embodiments of the present invention. For example, the accessory location device 110 can include a memory and store the identification information to the memory. Alternatively, the identification information can be stored to a storage space in a main processor of the accessory location device 110. The identification information can be physically recorded on a circuit of the accessory location device 110. The identification information can be recorded by adjustable mechanical means.

The identification information can be input in various ways according to the embodiments of the present invention. For example, the accessory location device 110 can include a port connectable with an external device and receive the identification information from the external device via the port. Alternatively, the accessory location device 110 can include a mechanical means (e.g., a dial) or an electronic means (e.g., key pad and function keys) for inputting the identification information, and can receive the identification information through the input means.

The message is transmitted to be received by a portable terminal near the accessory location device 110, without designating a particular destination, along with requests to provide the location information to the portable terminal of the identification information. The location information is estimated by the portable terminal which receives the message. In FIG. 1, the identification information is the identification information of the portable B 122, and the portable terminal A 121 travels near the accessory location device 110 and receives the message.

The portable terminal A 121 includes a location estimation module, receives the message from the accessory location device 110, estimates the location, and then provides the portable terminal B 122 of the identification information contained in the message with the estimated location information together with the identification information of the accessory location device 110. That is, the portable terminal A 121 parses the message, extracts the identification information in the message, and then transmits its location information and the identification information of the accessory location device 110. For example, the location estimation module estimates the location based on Global Positioning System (GPS), or estimates the location using a signal of a base station such as Time of Arrival (TOA) and Time Difference of Arrival (TDOA).

The location information is delivered via the communication network 130. For example, the communication network 130 can be a mobile communication network, Internet network, and the like. The location information can be transmitted in the form of a Short Message Service (SMS) message, an e-mail, a Social Network Service (SNS) contents, and a network only message.

The portable terminal A 121 can restrict particular identification information from being transmitted. For example, when the identification information is the identification information of the portable terminal A 121, it is unnecessary to provide the location information. Since it may be necessary to restrict providing the location information for various reasons, a feature restricting particular identification information from transmitting is provided.

The portable terminal B 122 receives the location information and the identification information of the accessory location device 110 from the portable terminal A 121 over the communication network 130. Although the location information indicates the location of the portable terminal A 121, not the location of the accessory location device 110. However, a user of the portable terminal B 122 can predict that the accessory location device 110 is in the vicinity of the portable terminal A 121 since the portable terminal A 121 received the message from the accessory location device.

For doing so, a pre-registration procedure is conducted between the portable terminal A 121 and the accessory location device 110. The user of the portable terminal A 121 registers the accessory location device 110 to the portable terminal A 121 and inputs the identification information of the portable terminal A 121 to the accessory location device 110. A user of the portable terminal B 122 installs the accessory location device 110 on an object to locate. For example, the accessory location device 110 can be installed on any object such as vehicle and notebook computer. The user of the portable terminal B 122 can attach the accessory location device 110 to a necklace and locate the particular person when the particular person (e.g., child) carries the accessory location device.

While the apparatus for providing the location information is the portable terminal in FIG. 1, any device capable of estimating location and accessing the communication network can be utilized. While the apparatus for receiving the location information is a portable terminal, any device capable of accessing the communication network can be utilized.

In FIG. 1, the message includes the identification information of the device to receive the location information, and the identification information of the accessory location device transmitting the message. Alternatively, the message may further include additional information. For example, the message can further include, as the additional information, information indicating a condition (e.g., time zone, region, etc.) for sending the location information.

Operations and structures of the accessory location device for requesting the location information and a provider for providing the location information are explained by referring to the drawings below.

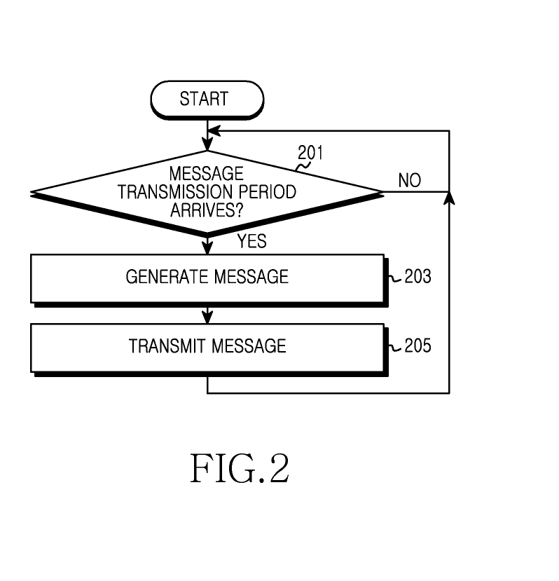

FIG. 2 is a flowchart of operations of the accessory location device in the wireless communication system according to an embodiment of the present invention.

Referring to FIG. 2, the accessory location device determines whether a message transmission period arrives in step 201. That is, the accessory location device periodically transmits the message at set time intervals.

When the transmission period arrives, the accessory location device generates the message in step 203. The message requests the location information to a particular device, and includes an indicator indicating the request of the location information, the identification information of the accessory location device, and the identification information of the particular device for receiving the location information. That is, the accessory location device loads the identification information recorded therein and generates messages including the identification information. In so doing, the identification information can be recorded in several ways according to the embodiments of the present invention. For example, the identification information can be stored to the memory of the accessory location device, stored to the storage space in the main processor of the accessory location device, physically recorded on the circuit of the accessory location device, or recorded by the adjustable mechanical means. The message may further include additional information in addition to the indicator and the identification information. Alternatively, the accessory location device can store the message as one data. In this case, the accessory location device generates the message by loading the stored message.

In step 205, the accessory location device transmits the message. That is, the accessory location device converts the message to a physical signal according to the short-range communication scheme supported by the accessory location device, and sends the signal. For example, the short-range communication scheme can adopt the RFID, the NFC, the Bluetooth®, and the like.

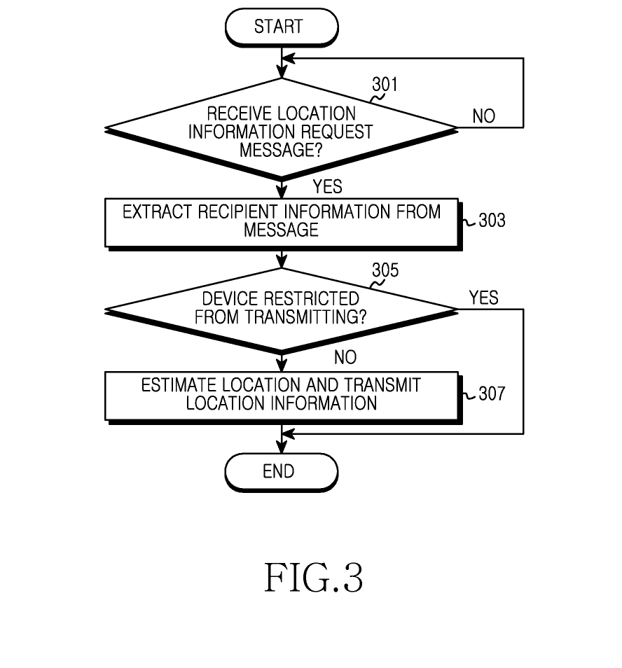

FIG. 3 is a flowchart of operations of a location information provider in the wireless communication system according to an embodiment of the present invention. For example, the location information provider can be a portable terminal.

Referring to FIG. 3, the location information provider determines whether the message requesting the location is received in step 301. The message includes the indicator indicating the request of the location information, the identification information of the accessory location device, and the identification information of the particular device for receiving the location information. Herein, the message is received according to the short-range communication scheme. For example, the short-range communication scheme can adopt the RFID, the NFC, the Bluetooth®, and the like.

Upon receiving the message, the location information provider extracts recipient information from the message in step 303. That is, the location information provider extracts the identification information of the particular device. For example, the identification information can be at least one of the phone number, the e-mail, the identifier allocated in the communication network, and the ID of the particular community service.

In step 305, the location information provider determines whether the particular device is restricted from transmitting to the location information. That is, the location information provider stores a list of devices restricted from transmitting to the location information, and determines whether the list includes the recipient information extracted in step 303. When the list includes the particular device, the location information provider does not provide the location information and finishes this process.

When the list does not include the particular device, the location information provider estimates its location and transmits the estimated location information to the particular device in step 307, along with the identification information of the accessory location device contained in the message. For example, the location information provider estimates the location using at least one of the GPS signal and the signal of the base station of the wireless communication network. In other words, the location information provider can estimate the location utilizing the GPS, or by using the signal of the base station such as TOA and TDOA. The location information can be transmitted in the form of the SMS message, the e-mail, the SNS contents, and the network only message.

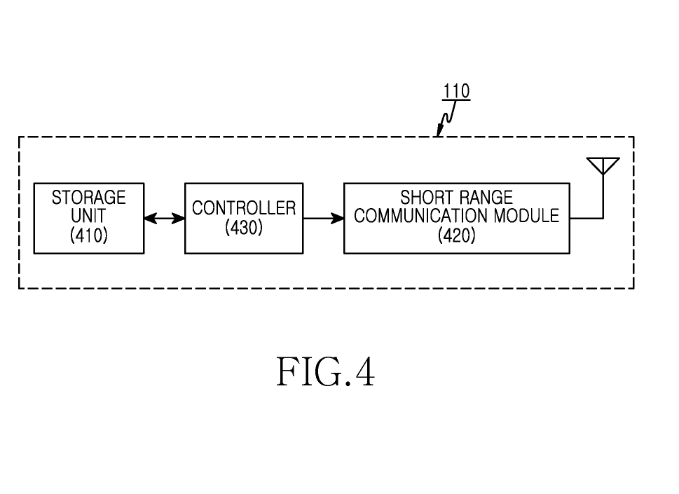

FIG. 4 is a block diagram of the accessory location device in the wireless communication system according to an embodiment of the present invention.

As illustrated in FIG. 4, the accessory location device 110 includes a storage unit 410, a short-range communication module 420, and a controller 430.

The storage unit 410 stores program codes and data required for the operations of the accessory location device 110. Particularly, the storage unit 410 stores the identification information of the accessory location device 110 and the identification information of the particular device which registers the accessory location device 110. In other embodiments of the present invention, the storage unit 410 can store the message including the identification information as one data. Herein, the storage unit 410 can be implemented in several ways. For example, the storage unit 410 can be any one of the memory in the accessory location device 110, the storage space in the main processor of the accessory location device 110, the data physically recorded on the circuit of the accessory location device 110, and the adjustable mechanical means.

The short-range communication module 420 transmits data output from the controller 430 according to the short-range communication scheme. In more detail, the short-range communication module 420 converts the message output from the controller 430 to the physical signal in the accessory location device 110 according to the corresponding short-range communication scheme, and transmits the signal. For example, the short-range communication scheme can adopt the RFID, the NFC, the Bluetooth®, and the like.

The controller 430 periodically generates the message according to the set time intervals and sends the message via the short-range communication module 420. The message requests the particular device to provide the location information, and includes the indicator indicating the request of the location information, the identification information of the accessory location device 110, and the identification information of the particular device to receive the location information. That is, the controller 430 loads the identification information recorded to the storage unit 410, generates the message including the identification information, and then provides the message to the short-range communication module 420.

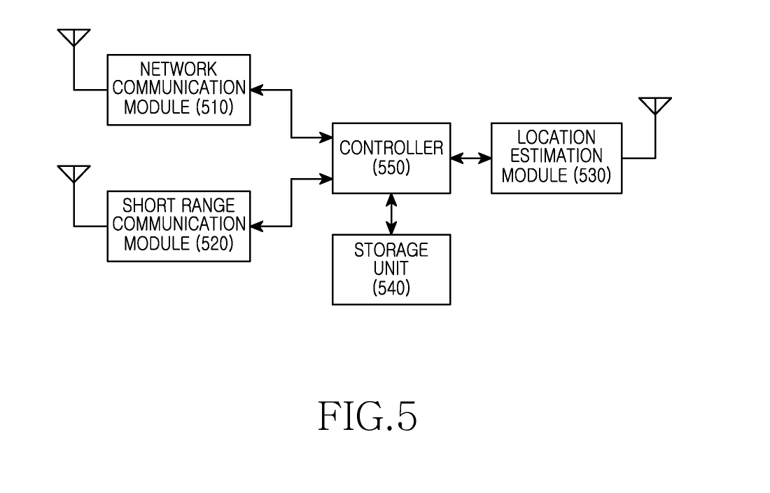

FIG. 5 is a block diagram of the location information provider in the wireless communication system according to an embodiment of the present invention.

As illustrated in FIG. 5, the location information provider includes a network communication module 510, a short-range communication module 520, a location estimation module 530, a storage unit 540, and a controller 550.

The network communication module 510 provides interface for accessing the wireless communication network. For example, the wireless communication network can include a cellular network, a broadband wireless access network, a wireless Local Area Network (LAN), and the like. That is, the network communication module 510 includes a modem for processing a baseband signal and a Radio Frequency (RF) module for processing an RF signal.

The short-range communication module 520 provides interface for receiving the signal transmitted according to the short-range communication scheme. The short-range communication module 520 has a reception function, and can further include a transmission function. For example, the short-range communication scheme can adopt the RFID, the NFC, the Bluetooth®, and the like.

The location estimation module 530 estimates the location of the location information provider. For example, the location estimation module 530 can estimate the location utilizing the GPS, or by using the signal of the base station such as TOA and TDOA.

The storage unit 540 stores programs, microcodes, and setup data required for the operations of the location information provider. In particular, the storage unit 540 recognizes the message transmitted from the accessory location device, and stores an application program for the function providing the location information according to the message. The storage unit 540 stores the list of the devices restricted from transmitting to the location information.

The controller 550 stores functions of the location information provider. More specifically, the controller 550 recognizes the message transmitted from the accessory location device and controls to provide the location information according to the message. Upon receiving the message requesting the location information via the short-range communication module 520, the controller 550 extracts the recipient information; that is, the identification information of the particular device from the message. For example, the identification information can be at least one of the phone number, the e-mail, the identifier allocated in the communication network, and the ID of the particular community service. The controller 550 loads from the storage unit 540 the list of the devices restricted from transmitting to the location information and then determines whether the particular device is set as the device restricted from transmitting to the location information. When the list does not include the particular device, the controller 550 estimates the current location by controlling the location estimation module 530, and transmits the estimated location information to the particular device via the network communication module 510. The location information can be transmitted in the form of the SMS message, the e-mail, the SNS contents, and the network only message.

By requesting the location information to other nearby devices using the short-range communication in the wireless communication system, the approximate location information of the accessory location device not having the location estimation function can be provided. Therefore, it is possible to obtain the location information a person or any particular object, without the cost of incorporating location estimation function.

Although several embodiments the present invention have been described, various changes and modifications may be made therein without departing from the spirit and scope of the invention as defined by the appended claims.

What is claimed is:

1. A method for an operation of an apparatus having a short-range communication function, the method comprising:
determining whether a message transmission period arrives; and
when the message transmission period arrives, transmitting a message comprising at least one of an indicator indicating that location information transmission is requested to a first device, identification information of the apparatus, and identification information of the first device.

2. The method of claim 1, wherein the short-range communication is based on one of Radio Frequency IDentifier (RFID), Near Field Communication (NFC), and Bluetooth®.

3. The method of claim 1, wherein the identification information of the first device comprises at least one of a phone number, an e-mail, an identifier allocated in a communication network, and an IDentifier (ID) of a particular community service.

4. A method for an operation of an apparatus having a location estimation function, the method comprising:
receiving a message from a first device requesting to transmit location information through short-range communication;
extracting identification information of a second device from the message;
estimating a current location of the apparatus; and
transmitting the estimated location information to the second device.

5. The method of claim 4, wherein the message comprises at least one of an indicator indicating that transmission of the location information is requested to the second device, identification information of the first device, and identification information of the second device.

6. The method of claim 4, wherein the short-range communication is based on one of Radio Frequency IDentifier (RFID), Near Field Communication (NFC), and Bluetooth®.

7. The method of claim 4, wherein the location is estimated using at least one of a Global Positioning System (GPS) signal and a signal of a base station of a wireless communication network.

8. The method of claim 4, wherein the location information is transmitted over a wireless communication network.

9. The method of claim 8, wherein the location information is transmitted in a form of at least one of a Short Message Service (SMS) message, an e-mail, a Social Network Service (SNS) contents, and a network only message.

10. The method of claim 4, further comprising:
before estimating the location, determining whether the extracted identification information of the second device is on a list of devices restricted from transmitting location information to.

11. An apparatus having a short-range communication function, the apparatus comprising:
a controller for determining whether a message transmission period arrives, and when the message transmission period arrives, generating a message comprising at least one of an indicator indicating that location information transmission is requested to a first device, identification information of the apparatus, and identification information of the first device; and
a short-range communication module for transmitting the generated message.

12. The apparatus of claim 11, wherein the short-range communication is based on one of Radio Frequency IDentifier (RFID), Near Field Communication (NFC), and Bluetooth®.

13. The apparatus of claim 11, wherein the identification information of the first device comprises at least one of a phone number, an e-mail, an identifier allocated in a communication network, and an IDentifier (ID) of a particular community service.

14. An apparatus having a location estimation function, the apparatus comprising:
a short-range communication module for receiving a message requesting to transmit location information from a first device;
a controller for extracting identification information of a second device from the message;
a location estimation module for estimating a current location of the apparatus; and
a network communication module for transmitting the estimated location information to the second device.

15. The apparatus of claim 14, wherein the message comprises at least one of an indicator indicating that location information transmission is requested to the second device, identification information of the first device, and identification information of the second device.

16. The apparatus of claim 14, wherein the short-range communication is based on one of Radio Frequency IDentifier (RFID), Near Field Communication (NFC), and Bluetooth®.

17. The apparatus of claim 14, wherein the location is estimated using at least one of a Global Positioning System (GPS) signal and a signal of a base station of a wireless communication network.

18. The apparatus of claim 14, wherein the location information is transmitted over a wireless communication network.

19. The apparatus of claim 18, wherein the location information is transmitted in a form of at least one of a Short Message Service (SMS) message, an e-mail, a Social Network Service (SNS) contents, and a network only message.

20. The apparatus of claim 14, wherein, before estimating the location, the controller determines whether the extracted identification information of the second device is on a list of devices restricted from transmitting location information to.
